(19) United States
(12) Patent Application Publication
(10) Pub. No.: US 2011/0153520 A1
(43) Pub. Date: Jun. 23, 2011

(54) Asset Investment Simulation System Based on Investment Behavior Analysis, Time Compression, and Event Re-Sequencing

(75) Inventors: Yih JENG, Kaosiung City (TW); Yi-Yu CHEN, Kaohsiung City (TW)

(73) Assignee: Folion Financial Technology Co., Ltd.

(21) Appl. No.: 12/642,768

(22) Filed: Dec. 19, 2009

(30) Foreign Application Priority Data
Dec. 19, 2009 (TW) 097149591

(51) Int. Cl. G06Q 40/00; G06F 17/30

(52) U.S. Cl. 705/36 R; 707/705; 707/E17.001

(57) ABSTRACT

A asset investment simulation system based on investment behavior analysis, time compression, and event re-sequencing has a network server containing a user profile module for account and password management, an event database containing domestic and international events that affected the financial market, a scenario module for selection of country of investment and time period, an economic windows module for market news for the determination of investment target and amount, an asset allocation module for portfolio suggestions, a trading interface for online trading upon reviewing news messages and economic indexes, a performance evaluation module for performance management and detail data display of account value, portfolio, and performance, and an investment behavior analysis module for investment behavior analysis and investment behavior suggestions.

### BACKGROUND OF THE INVENTION

1. Field of the Invention

This invention is an asset investment simulation system based on investment behavior analysis, time compression, and event re-sequencing, using database containing long-term historical events in index trading similar to mutual funds and account management. By using the system and going through various financial environments, the user detects his or her own investment blind spots, and learns to form more effective investment habits.

2. Descriptions of the Prior Art

Individual investors tend to focus on stocks, mutual funds, futures, options, and CD's as investment targets, or to follow asset management consultants' advices to increase net worth and achieve investment goals. However, investment does not always earn the expected profits because investment involves risks. In addition to one's luck, market trends, economic trends, and individual financial decisions all affect the outcome of one's investment. With all these factors and uncertainties, if the investor does not have a clear direction, he will most likely end up with significant negative returns. Therefore if the investor can experience the markets and evaluate his investment behavior before actually investing, he will be able to find his blind spots and weaknesses, gain valuable investment experience through repeated practices, reduce risks, and enjoy higher and more stable profit margins when facing the turbulent financial markets.

The wealth management systems currently available on the market to the general public have very limited features and often do not meet the needs of individual investors.

The inventor addresses problems and inadequacy of the existing systems on the market and successfully invented this perfected new asset investment simulation system based on investment behavior analysis, time compression, and event re-sequencing as an effective and comprehensive investment tool for the general individual investors.

### SUMMARY OF THE INVENTION

The primary objective of this invention is to provide an asset investment simulation system based on investment behavior analysis, time compression, and event re-sequencing whose event database collects significant historical domestic and international events in the financial market. The system creates an event time zone to place the events in chronological order to simulate history, or rearrange them randomly to create uncertainties and market turbulence in simulation.

The second objective of this invention is to provide an asset investment simulation system that uses events from the event database for simulated trading. This feature enables the system to randomize events and compress the history of financial markets, allowing the user to experience several decades' worth of economic and political events in a just few hours. The simulated experience helps the user become accustomed to the ever-changing financial markets, and to remain focused and rational when facing market turbulence in reality.

The third objective of this invention is to provide an asset investment simulation system that improves the users' investment EQ's (emotional intelligence) with various scenarios generated by the event database. Users learn not to panic or be overwhelmed by greed, but staying calm and focused instead, and make wise investment moves to profit in the turbulent financial markets.

The fourth objective of this invention is to provide an asset investment simulation system that analyzes the user's investment behavior during the simulation and detects individual blind spots. The result helps the investor be reminded of his or her own weaknesses, and be able to realign investment strategies when facing the real financial markets.

The asset investment simulation system consists of an event database and seven modules pertaining to the following areas respectively: user profile, scenarios, economic windows, asset allocation, online trading, performance evaluation, and investment behavior analysis. The user profile module controls user accounts, passwords, and the financial targets which can be reviewed after the simulation. The event database stores the domestic and international events that affected the financial market and can re-sequence the events within reasonable limits. The scenarios module controls the selection of country, time and duration of investment. The economic windows module provides market news for investment target purposes. The asset allocation module provides investment suggestions and quantitative frontier performance allocation to reduce risks. The online trading module provides a trading interface for users to submit orders online upon reviewing news events and economic indexes. The performance evaluation module displays performance, account net value and portfolio in table form as well as graphic chart form. The investment behavior analysis module assesses the user's investor confidence, media influence index, buy high and sell low behavior, risk tolerance, emotional fluctuation, etc. and provides investment suggestions accordingly.

### BRIEF DESCRIPTION OF THE DRAWINGS

Please refer to the following figures for technical details of this invention. The figures include the follows:

FIG. 1 shows the structure of this invention of asset investment simulation system based on investment behavior analysis, time compression, and event re-sequencing;

FIG. 2 shows the structure of the scenario module of this invention of asset investment simulation system based on investment behavior analysis, time compression, and event re-sequencing;

FIG. 3 shows the structure of the user profile module of this invention of asset investment simulation system based on investment behavior analysis, time compression, and event re-sequencing;

FIG. 4 shows the structure of the economic windows module of this invention of asset investment simulation system based on investment behavior analysis, time compression, and event re-sequencing;

FIG. 5 shows the structure of the asset allocation module of this invention of asset investment simulation system based on investment behavior analysis, time compression, and event re-sequencing;

FIG. 6 shows the structure of the online trading module of this invention of asset investment simulation system based on investment behavior analysis, time compression, and event re-sequencing;

FIG. 7 shows the structure of the performance evaluation module of this invention of asset investment simulation system based on investment behavior analysis, time compression, and event re-sequencing; and

FIG. 8 shows the structure of the investment behavior analysis module of this invention of asset investment simulation system based on investment behavior analysis, time compression, and event re-sequencing.

### DETAILED DESCRIPTION OF THE PREFERRED EMBODIMENT

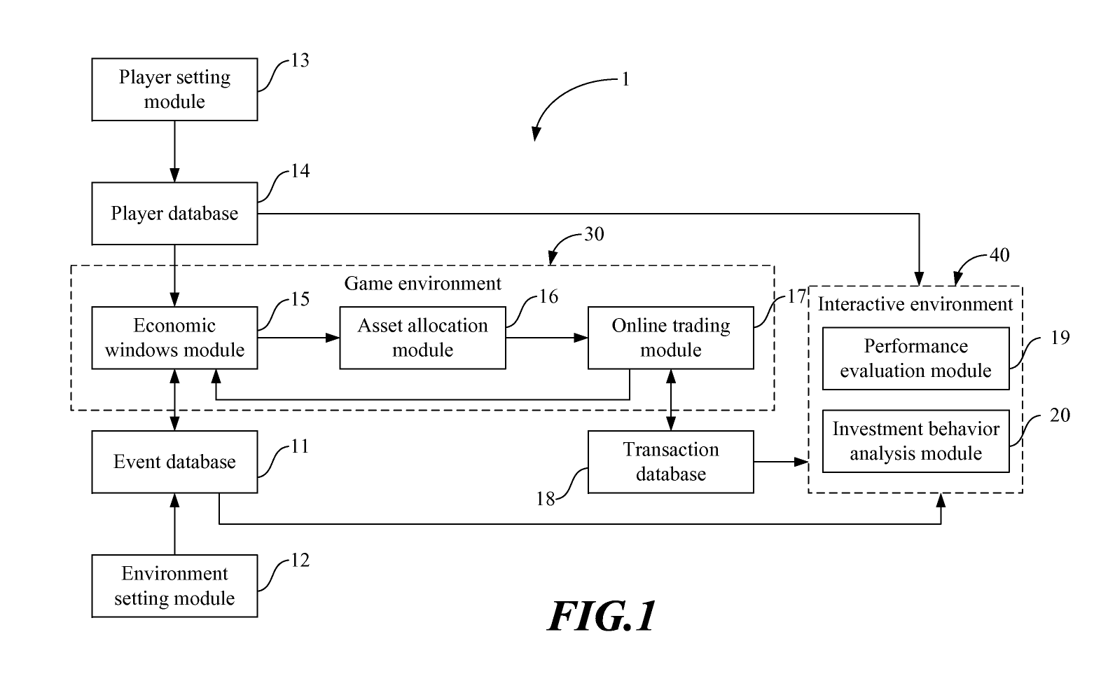

Please refer to FIGS. 1 through 8 for this invention of asset investment simulation system based on investment behavior analysis, time compression and event re-sequencing consisting of the following.

An event database module 11 contains major domestic and international news events that affected the financial markets. Such events include important financial incidents, announcements of significant theories, wars, political incidents, strikes, natural disasters, and their causes and consequences. The event database module 11 is also preset with “chance and community chest” like winning lotteries, layoffs, and traffic fines. In addition, the event database mimics the CD player to shuffle, combine, and edit events within reasonable limits for a given theme and time period. For example, interest rate will not be raised today if it was dropped yesterday, and there will be no presidential election next month if it was held this month, etc. The concept works like that of a CD player. When a CD (data) was selected and played (simulated), it plays the contents designed for it. Each different CD plays a different theme or time period.

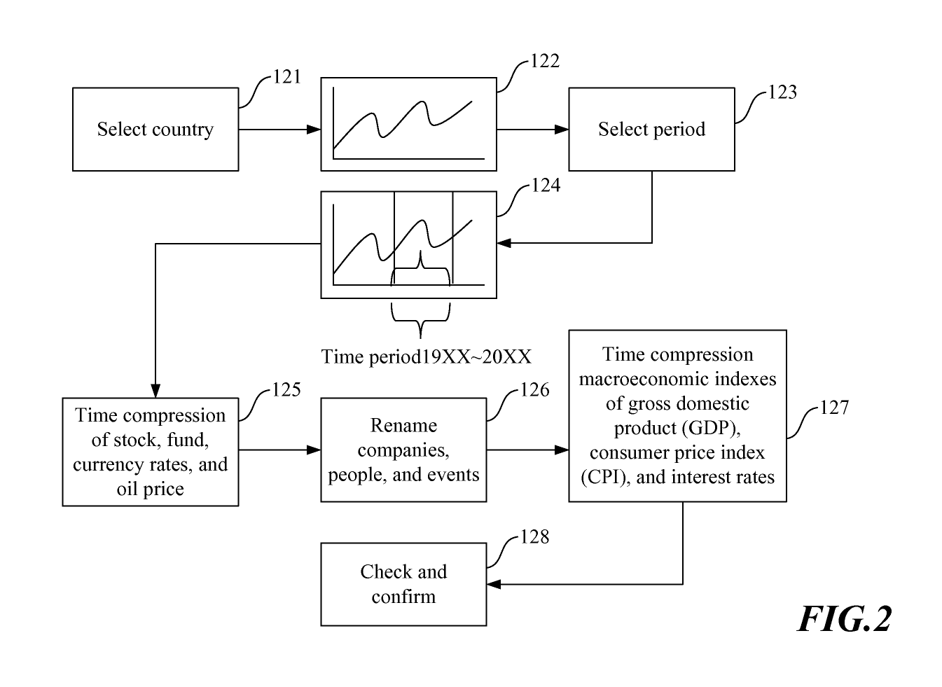

A scenario module 12 as seen in FIG. 2 lets the user select a simulated country 121 in the event database 11 such as Taiwan, United States, or a European country to invest in as the investment environment. The chart of the stock market of the selected country is displayed on the monitor 122 for the user to set the simulation investment period 123. If the selected time period is from year 19xx to 20xx, the monitor only shows the stock trend chart 124 of this period. It can also rearrange and edit the stored events in the event database 11 for the simulation. The information that can be rearranged or edited are (1) time compression of the markets of stock, fund, currency, and oil price 125, (2) renaming of companies, people, and events 126, and (3) time compression of gross domestic product (GDP), consumer price index (CPI), and interest rates 127. With investment time compressed, users can finish the long-term investment simulation in a few hours. After the events are rearranged, users can check and confirm if the settings are correct 128.

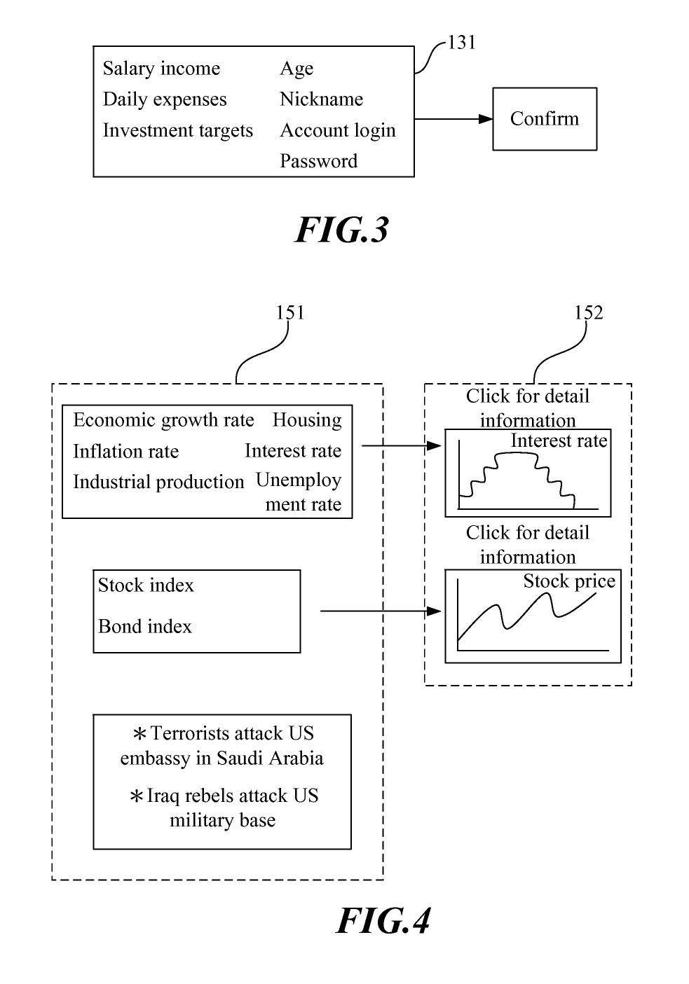

A user profile module 13 as shown in FIG. 3 contains a role selection module 131 allowing the user to set salary, income, daily expenses, investment targets, and personal profile like age, nickname, account login and password in the user database 14. The user can find the competitor list from the user database 14 to see who else is in the game and the instructor can use it to create the competitor list.

When done with the scenario module 12 and the user profile module 13, the user can go to the game environment 30 to start the simulation. The game environment 30 consists of the following:

An economic windows module 15 as shown in FIG. 4 which contains a display module 151 and a selection module 152. The display module 151 can show (1) macroeconomic indexes like economic growth rate, housing inflation rate, interest rate, industrial production indexes, unemployment rate, and further detail data when module 152 is selected, (2) numbers from the stock and bond markets, for example, stock and bond indexes, with detail data when module 152 is selected, and (3) news messages like a terrorist attack on the US embassy in Saudi Arabia, or an Iraqi rebel attack on a US military base. Furthermore, the economic windows 15 can follow the instructor's setting to display various market messages as time goes on during the simulation for the users to determine the investment target and amount.

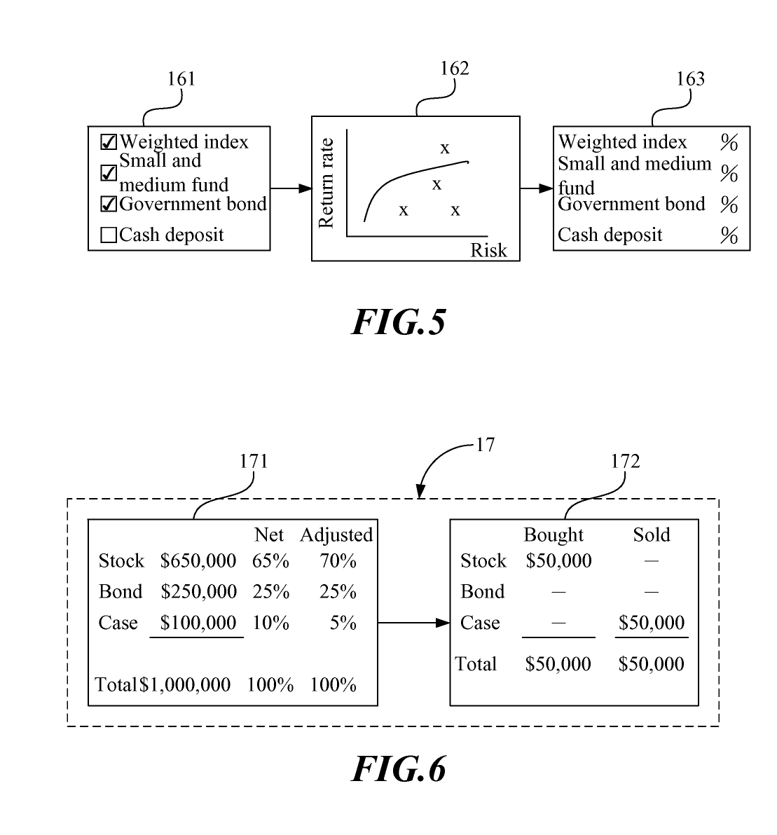

An asset allocation module 16 as shown in FIG. 5 has an investment target selection module 161, an efficiency allocation display module 162, and an investment ratio display module 163. The investment target selection module 161 and investment ratio display module 163 contain options for displaying weighted indexes, small and medium funds, government bonds, or fixed deposit interest rates. The efficiency allocation display module 162 provides related charts for return rates and risks. This asset allocation module 16 is designed as an add-on. When the user is unsure about his investment, the asset allocation module 16 can propose an investment portfolio for the user's reference. This asset allocation module can calculate the investment ratio to find the best portfolio with the least risk and highest return. Using this asset allocation module 16 with individualized investment attributes and numerated efficient frontier allocation, the user can expect to more efficiently gain stable returns and achieve financial goals.

The online trading module 17 as shown in FIG. 6 has an account management display module 171 and a trading detail display module 172. The account management display module 171 displays the current values and adjusted values of stock, bond, and cash. The trading detail display module 172 displays the trading status for stock, bond, and cash. The simulation works just like the real world. The player can place an order in the online trading module 17 using virtual money. When the orders are submitted, the user can use the information from economic windows 14 to execute additional simulated transactions and the order history will be stored in the transaction database 18. User can use the transaction database 18 to record cost of investment and net account value change.

If the user wants to know the investment performance or analyze individual investment behavior, the user can switch to the interactive environment 40 which includes the following.

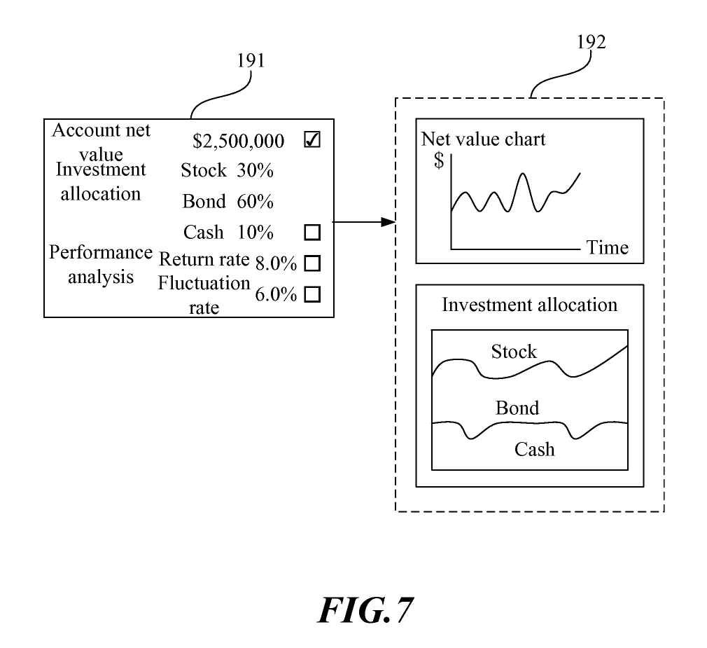

A performance evaluation module 19 as shown in FIG. 7 which has a performance management module 191 and a detail data display module 192. The performance management module 191 displays the account net value, portfolio, performance analysis, with conjunction of the detail data display module 192 to show the net value chart and the asset allocation chart.

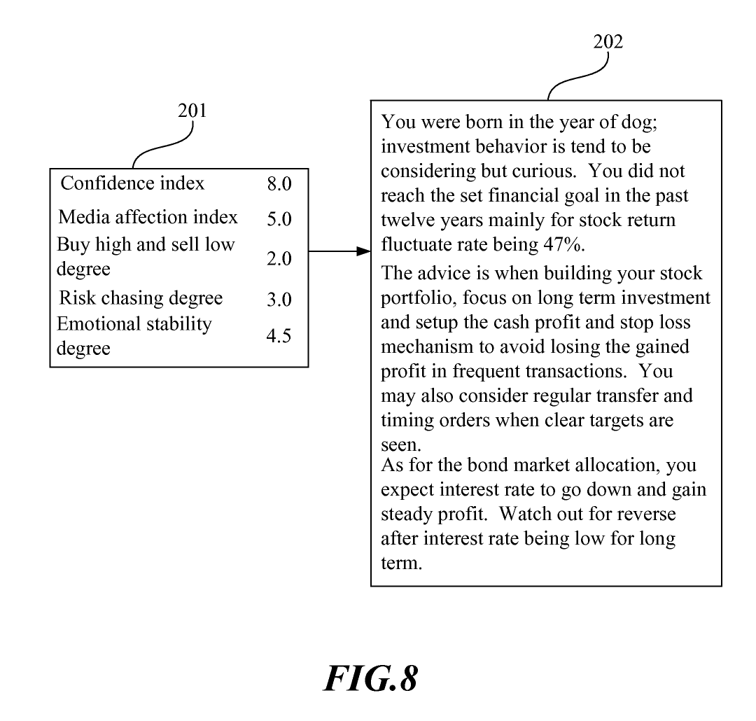

An investment behavior analysis module 20 as shown in FIG. 8 which has an investment behavior analysis display module 201 and an investment behavior suggestion module 202. The investment behavior analysis display module 201 shows the confidence index, media influence index, buy high and sell low index, risk chasing index, and emotional fluctuate degree. The investment behavior suggestion module 202 can analyze and give advice on the result of the simulation, such as “You were born in the year of the dog; and your investment behavior tends to be cautiously curious. You did not reach the pre-set financial goal in the past twelve years mainly because of the 47% fluctuate rate on stock returns. It is suggested that, when building your stock portfolio, focus on long term investment and set up the cash profit and stop loss mechanism to avoid unrealized gain loss in frequent transactions. You may also consider automatic investments as well as lump sum investment when the time is right. As for the bond market allocation, you expect interest rate to go down and gain steady profit. Watch out for the opposite after interest rate being low for too long.”

Also, the performance evaluation module and the investment behavior analysis module will both access the user database, the transaction database, and the event database to determine the performance evaluation and investment suggestions.

The asset investment simulation system based on investment behavior analysis, time compression and event re-sequencing provided in this invention has the following advantages over current technology:
1. The event database in this invention stores major domestic and international historical events that affected the financial market. The events are time compressed so that the user can weather all the market's ups and downs in a short time to learn to adjust strategically for different situations, be more aware of economic and environment changes, and gain more sensitivity to reduce investment errors.
2. This invention uses an event database for users to perform simulated investments and record their behaviors during simulations. It also uses behavioral investment study to analyze the user's investment behavior in order for the user to know his or her own weaknesses and blind spots and overcome foreseeable investment mistakes in the real financial market.

The aforementioned descriptions are solely for explaining the embodiments of the present invention and are not intended to limit the scope of the present invention. Any equivalent practice of modification within the spirit of the present invention should be treated as being within the scope of patent of the present invention.

As aforementioned, the present invention is novel in technology and advantageous in many effects that the prior arts lack. The present invention conforms to the novelty and non-obviousness of patentability.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An asset investment simulation system based on investment behavior analysis, time compression, and event re-sequencing, comprising:
an event database storing impact and duration of historic domestic and international events that affected a financial market;
a scenario module to select a country for simulation from the event database, rearrange events from the database and compress time to go through the simulation in a short time;
wherein when these settings are done, a user can go to a game environment to start the investment simulation, and the game environment has:
an economic windows module to display market messages for the user to see and determine investment targets and amounts;
an asset allocation module to display choices for the investment targets and provides suggestions on investment based on risk vs. return;
an online trading module to show current and adjusted values on the simulation investment and trading status;
when orders are submitted, the user is able to use market messages on economic windows and investment choices in the asset allocation module to make more investment.

2. The asset investment simulation system based on investment behavior analysis, time compression, and event re-sequencing as claimed in claim 1, wherein the user profile module has a role selection module for the user to set various data and store selections in user database.

3. The asset investment simulation system based on investment behavior analysis, time compression, and event re-sequencing as claimed in claim 2, wherein the role selection module lets the user input information of salary, income, daily expenses, investment targets, and personal profile of age, nickname, account login and password to be stored in the user database.

4. The asset investment simulation system based on investment behavior analysis, time compression, and event re-sequencing as claimed in claim 2, wherein the user profile module provides a competitor list for the user to search.

5. The asset investment simulation system based on investment behavior analysis, time compression, and event re-sequencing as claimed in claim 1, wherein the event database can be retrieved and re-sequenced within reasonable limits for a given theme and time period for the simulation, and each and every theme or time period will call upon its unique corresponding historical events from the database.

6. The asset investment simulation system based on investment behavior analysis, time compression, and event re-sequencing as claimed in claim 1, wherein the scenario module is configured to re-sequence and compress history of stock, bond, fund, currency rates, and oil price.

7. The asset investment simulation system based on investment behavior analysis, time compression, and event re-sequencing as claimed in claim 1, wherein the scenario module is configured to rename companies, people, and events.

8. The asset investment simulation system based on investment behavior analysis, time compression, and event re-sequencing as claimed in claim 1, wherein the scenario module is configured to rearrange, and time compress a history of gross domestic product (GDP), consumer price index (CPI), and interest rates.

9. The asset investment simulation system based on investment behavior analysis, time compression, and event re-sequencing as claimed in claim 1, wherein the economic windows module contains a display module and a selection module.

10. The asset investment simulation system based on investment behavior analysis, time compression, and event re-sequencing as claimed in claim 9, wherein the display module is configured to display macroeconomic indexes, stock and bond indexes, and news messages.

11. The asset investment simulation system based on investment behavior analysis, time compression, and event re-sequencing as claimed in claim 9, wherein the selection module is configured to bring up detail information for the display module.

12. The asset investment simulation system based on investment behavior analysis, time compression, and event re-sequencing as claimed in claim 1, wherein the asset allocation module has an investment target selection module, an efficiency allocation display module, and an investment ratio display module.

13. The asset investment simulation system based on investment behavior analysis, time compression, and event re-sequencing as claimed in claim 12, wherein the investment target selection module and investment ratio display module provide options for weighted indexes, small and medium funds, government bonds, or fixed deposit interest rates.

14. The asset investment simulation system based on investment behavior analysis, time compression, and event re-sequencing as claimed in claim 12, wherein the efficiency allocation display module provides related charts for return rate and risk.

15. The asset investment simulation system based on investment behavior analysis, time compression, and event re-sequencing as claimed in claim 1, wherein the online trading module contains an account management display module and a trading detail display module.

16. The asset investment simulation system based on investment behavior analysis, time compression, and event re-sequencing as claimed in claim 15, wherein the account management display module is configured to display current values and adjusted values for stock, bond, and cash.

17. The asset investment simulation system based on investment behavior analysis, time compression, and event re-sequencing as claimed in claim 15, wherein the trading detail display module is configured to display a trading situation for stock, bond, and cash.

18. The asset investment simulation system based on investment behavior analysis, time compression, and event re-sequencing as claimed in claim 1, wherein the interactive environment has a performance evaluation module and an investment behavior analysis module.

19. The asset investment simulation system based on investment behavior analysis, time compression, and event re-sequencing as claimed in claim 18, wherein the performance evaluation module contains performance management module and detail data display module.

20. The asset investment simulation system based on investment behavior analysis, time compression, and event re-sequencing as claimed in claim 19, wherein the performance management module shows an account net value, portfolio, and performance analysis.

21. The asset investment simulation system based on investment behavior analysis, time compression, and event re-sequencing as claimed in claim 19, wherein the detail data display module shows a net value chart and a allocation chart.

22. The asset investment simulation system based on investment behavior analysis, time compression, and event re-sequencing as claimed in claim 18, wherein the investment behavior analysis module contains an investment behavior analysis display module and an investment behavior suggestion module.

23. The asset investment simulation system based on investment behavior analysis, time compression, and event re-sequencing as claimed in claim 18, wherein the performance evaluation module and the investment behavior analysis module both are configured to consult user database and transaction database, associate with analyzed data from the event database, to determine a performance evaluation and investment suggestions.
